(19) United States
(12) Patent Application Publication
(10) Pub. No.: US 2004/0029526 A1
(43) Pub. Date: Feb. 12, 2004

(54) Image transmitting method, image transmitter, and memory product

(75) Inventors: Atsushi Miki, Kato (JP); Shuji Kimura, Kato (JP); Keiji Fujiwara, Kato (JP); Satoshi Fukui, Kato (JP); Kiyoshi Chinzei, Kato (JP); Mieko Nakano, Kato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/630,907

(22) Filed: Jul. 31, 2003

(30) Foreign Application Priority Data
Aug. 8, 2002 (JP) 2002-232081

(51) Int. Cl. H04B 7/15

(52) U.S. Cl. 455/11.1; 455/95

(57) ABSTRACT

When an image transmitter and a mobile phone are connected, it is determined whether or not a connection (communication) is established between a communication section and the mobile phone. If it is determined that the connection is established, the image transmitter transmits to the mobile phone a signal to request the mobile phone to obtain identification information given to the mobile phone. The image transmitter determines whether or not pre-stored identification information in the storage unit and the obtained identification information match. If it is determined that the identification information matches, the image transmitter reads image data stored in the storage unit and transmits the image data to the mobile phone.

### BACKGROUND OF THE INVENTION

1. Field of the Invention

The present invention relates to an image transmitting method and an image transmitter, for storing image data captured from an image capturing unit in a storage unit, reading the stored image data and then transmitting the image data from a communication section to a mobile phone having a display section, and also relates to a memory product storing a computer program for realizing the functions of the image transmitter. The present invention relates particularly to an image transmitting method capable of transmitting a captured image only to a specified mobile phone.

2. Description of the Prior Art

In recent years, mobile phones having a liquid crystal display with a large display area are on the increase. Accordingly, a technique for displaying an image captured from an external device as a standby screen on the liquid crystal display is widely used. Moreover, with the spread of digital cameras, a technique to connect a digital camera and a mobile phone with a cable, transmit image data taken by the digital camera to the mobile phone and display the image data as the standby screen on the display section of the mobile phone is known. In addition, it was proposed to transmit an image captured by a handy scanner to a mobile phone and display the image as the standby screen on the display section of the mobile phone.

However, digital cameras and handy scanners which are easy to carry have the high possibility of being lost or stolen. In this event, there is the problem that the captured image data is seen by a third party. In particular, since such a piece of image data is personal information, it needs to be protected adequately. Then, in order to enhance security, there may be an option to provide a digital camera, handy scanner, etc. with an operation button and a display section and require the entry of a password for authentication. In this case, however, there is the problem of an increase in the costs.

### BRIEF SUMMARY OF THE INVENTION

The present invention has been made with the aim of solving the above problems. An object of the present invention is to provide an image transmitting method and an image transmitter, which allow only a person having access rights to browse image data by performing authentication between identification information given to a mobile phone and pre-registered identification information when making a connection, and also a memory product storing a computer program for realizing the functions of the image transmitter.

An image transmitting method of the present invention is an image transmitting method for storing image data captured from an image capturing unit in a storage unit, reading the stored image data and transmitting the read image data from a communication section to a mobile phone having a display section, and characterized by comprising the step of determining whether or not a connection is established between the communication section and the mobile phone; a requesting step for requesting the mobile phone to obtain identification information given to the mobile phone, if it is determined that the connection is established; a determining step for determining whether or not pre-stored identification information in the storage unit and the identification information obtained in the requesting step match; and the step of reading the image data stored in the storage unit and transmitting the image data to the mobile phone, if it is determined in the determining step that the identification information matches.

An image transmitter according to the present invention is an image transmitter for storing image data captured from an image capturing unit in a storage unit, reading the stored image data and transmitting the read image data from a communication section to a mobile phone having a display section, and characterized by comprising: means for determining whether or not a connection is established between the communication section and the mobile phone; requesting means for requesting the mobile phone to obtain identification information given to the mobile phone, if it is determined that the connection is established; determining means for determining whether or not pre-stored identification information in the storage unit and the identification information obtained in the requesting means match; and means for reading the image data stored in the storage unit and transmitting the image data to the mobile phone, if it is determined by the determining means that the identification information matches.

An image transmitter according to the present invention is characterized by further comprising means for prohibiting a transmission of the image data stored in the storage unit to the mobile phone, if it is determined by the determining means that the identification information does not match.

An image transmitter according to the present invention is based on the second invention and characterized by further comprising: image processing means for performing image processing on the image data stored in the storage unit, if it is determined by the determining means that the identification information does not match; and means for transmitting the image data on which the image processing was performed by the image processing means to the mobile phone.

An image transmitter according to the present invention is characterized by further comprising means for providing information indicating that the identification information does not match, if it is determined by the determining means the identification information does not match.

An image transmitter according to the present invention is characterized in that the identification information is a phone number, an electronic mail address, a password, a model code, or a serial number of the mobile phone.

An image transmitter according to the present invention is characterized in that the image processing means is designed to add pre-stored character data or image data in the storage unit to image data stored in the storage unit, or replace the image data stored in the storage unit by the pre-stored character data or image data.

An image transmitter according to the present invention is characterized in that the image processing means is designed to change resolution of the image data stored in the storage unit.

A computer-readable memory product according to the present invention is a memory product storing a computer program for storing image data captured from an image capturing unit in a storage unit, reading the stored image data and transmitting the read image data from a communication section to a mobile phone having a display section, and characterized by storing a computer program for causing a computer to execute the step of determining whether or not a connection is established between the communication section and the mobile phone; a requesting step of requesting the mobile phone to obtain identification information given to the mobile phone, if it is determined that the connection is established; a determining step of determining whether or not pre-stored identification information in the storage unit matches the identification information obtained in the requesting step; and the step of reading image data stored in the storage unit and transmitting the image data to the mobile phone, if it is determined in the determining step that the identification information matches.

In the present invention, first, a mobile phone and an image transmitter are connected for initial registration. When the connection is established, the image transmitter requests the mobile phone to obtain identification information given to the mobile phone. As the identification information, there is, for example, the phone number, electronic mail address, password, model code, or serial number of the mobile phone. The image transmitter stores the obtained identification information as information about a person having access rights in a storage unit. When transmitting an image, image data is captured from an image capturing unit such as a CCD (Charge Coupled Device) or a line image sensor. Then, the captured image data is stored in the storage unit.

Thereafter, when the image transmitter and the mobile phone are connected, then it is determined whether or not a connection (communication) is established between the communication section and the mobile phone. If it is determined that the connection is established, the image transmitter transmits to the mobile phone a signal to request the mobile phone to obtain identification information given to the mobile phone. The image transmitter determines whether or not pre-stored identification information in the storage unit and the obtained identification information match. If it is determined that the identification information matches, the image transmitter reads the image data stored in the storage unit and transmits the image data to the mobile phone. It is therefore possible to prevent mobile phones of persons other than a person having access rights from being connected and displaying image data. Moreover, since there is no need to enter a password, etc., it is not necessary to newly provide hardware devices such as an operation button and a display screen, and thus it is possible to provide a high security image transmitter at low cost.

In the present invention, the image transmitter determines whether or not the pre-stored identification information in the storage unit and the obtained identification information match. If it is determined that the identification information does not match, the image transmitter informs that the identification information does not match by emission of an LED, for example, and prohibits a transmission of an image or performs image processing on the image data to be transmitted. In the image processing, for example, the resolution is charged, the pre-stored image data or character data is added to the obtained image data, or the obtained image data is replaced by the pre-stored character data or image data. With this structure, even when a third party obtains the image transmitter, the image data can not be properly displayed on the mobile phone of the third party, and thus it is possible to adequately protect privacy.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing the outline of the present invention;

FIG. 2 is a block diagram showing the hardware structure of a handy scanner according to the present invention;

FIG. 3 is a flow chart showing the procedure for initial registration of identification information;

FIGS. 4A through 4C are a flow chart showing the procedure for performing the authentication process and transmission process;

FIG. 5 is an explanatory view showing the image of image data displayed on a display section; and

FIG. 6 is a schematic view showing the outline of a handy scanner, etc. according to the second embodiment.

### DESCRIPTION OF THE PREFERRED EMBODIMENTS

First Embodiment

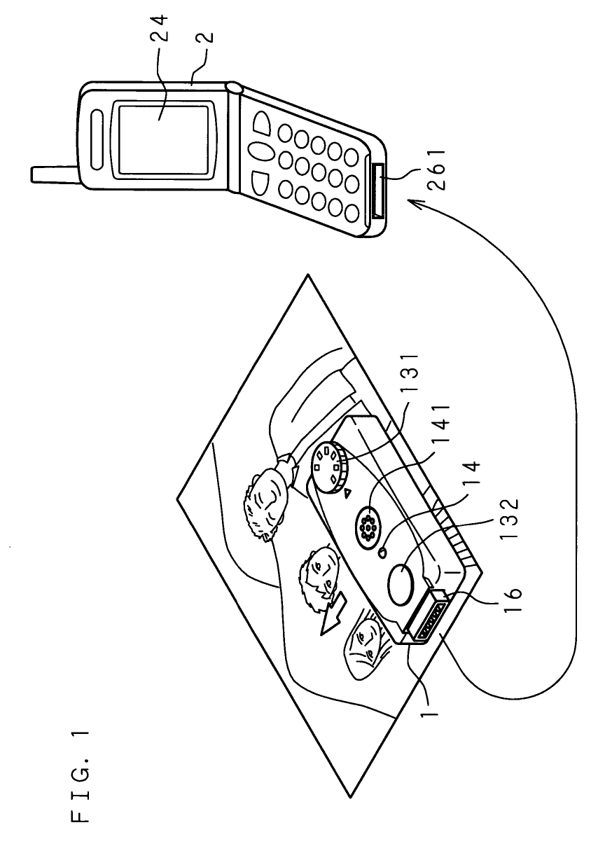

FIG. 1 is a schematic view showing the outline of the present invention. In FIG. 1, the numeral 1 is an image transmitter according to the present invention. For example, a handy scanner, a digital still camera, a digital video camera or the like is used. Note that the following explanation is given based on the assumption that the image transmitter 1 is a handy scanner 1. The handy scanner 1 has on its front surface a mode selection button 131 for selecting a scan mode, a transmission mode, etc.; and a scanning start/transmission button 132 that is used to start scanning and transmit captured image data to a mobile phone 2.

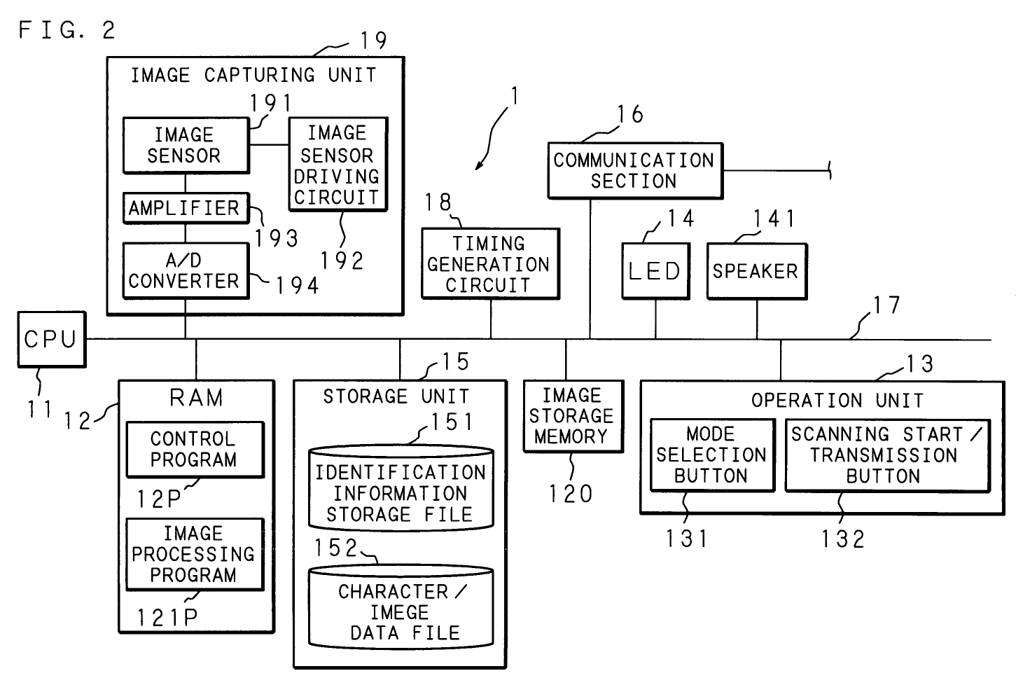

An image sensor (see FIG. 2) 191 constituting an image capturing unit 19 (see FIG. 2) is placed to appear on the rear surface of the handy scanner 1. After positioning the mode selection button 131 to the scan mode, when the scanning start/transmission button 132 is pressed, the image sensor is activated to capture an image. To transmit the captured image data to the mobile phone 2, a communication section 16 protruding from one end of the handy scanner 1 is fitted into an external device I/F 261 provided in the mobile phone 2.

Then, the mode selection button 131 is positioned to the transmission mode, and the scanning start/transmission button 132 is pressed. Accordingly, after performing authentication with the mobile phone 2, the image data is transmitted. Thereafter, the image data is displayed on a display section 24 of the mobile phone 2. Note that, in this embodiment, the mobile phone 2 and the handy scanner 1 are physically connected through the communication section 16. However, the present invention is not necessarily limited to this, and may transmit and receive information by using communication means such as infrared communication or Blue Tooth. The numeral 14 is an LED (Light Emitting Diode), and 141 is a speaker. They emit light or output sound when executing various operations.

FIG. 2 is a block diagram showing the hardware structure of the handy scanner 1 according to the present invention. The handy scanner 1 is connected through a bus 17 to a CPU (Central Processing Unit) 11, image capturing unit 19, operation unit 13, storage unit 15, timing generation circuit 18, RAM (Random Access memory) 12, image storage memory 120, communication section 16, LED 14, speaker 141, etc.

The CPU 11 is connected to each of the above-mentioned hardware devices of the handy scanner 1 through the bus 17. Then, the CPU 11 controls these devices, and also executes various software functions, according to a control program 12P and an image processing program 121P stored in the RAM 12. For the control program 12P, the following software processes are written in programming languages such as C language and Java (registered trademark). The image processing program 121P performs functions similar to those of known image processing software, and executes resolution conversion and combining of image data. The image capturing unit 19 is composed of an image sensor (line image sensor) 191, an image sensor driving circuit 192, an amplifier 193, and an AID converter 194.

By pressing the scanning start/transmission button 132 of the operation unit 13, a drive signal is outputted from the image sensor driving circuit 192 to the image sensor 191, and reading of a document image is started. Analog image signals of the document image formed by an optical system of the image sensor 191 are amplified by the amplifier 193, and then converted into digital image data by the A/D converter 194. The converted image data is stored in the image storage memory 120 such as a DRAM (Dynamic Random Access Memory). The timing generation circuit 18 outputs timing signals for the operations of hardware devices such as the image capturing unit 19 and the communication section 16. The communication section 16 is an interface for performing transmission and receiving of commands between the communication section 16 and the mobile phone 2, transmission of image data, etc. The communication section 16 and the external device I/F 261 of the mobile phone 2 are connected with a cable. Note that the transmission and receiving of information may be performed by Blue Tooth as described above. In this case, in order to communicate with the mobile phone 2 by using 2.45 GHz radio wave, a wireless aerial part, a RF (Radio Frequency) part, a base band part, a quartz oscillator, etc. (not shown) need to be mounted in the communication section 16. Alternatively, the information may be transmitted and received to/from the mobile phone 2 by infrared communication. In this case, a signal transmitting and receiving part for infrared communication (not shown) needs to be mounted in the communication section 16.

As the communication means, for example, the LED 14, speaker 141, etc. are used as in this embodiment, and light is emitted or sound is outputted when performing various operations. As described above, the operation unit 13 is composed of the mode selection button 131 and the scanning start/transmission button 132. For the mode selection button 131, a “power off mode”, and three modes, namely, “scan mode small”, “scan mode middle” “scan mode large” (which are represented as “scan mode” in some case) are prepared according to a read area. In addition, a “transmission mode” to the mobile phone 2 is prepared. One mode is selected by setting the mode selection button 131 in the form of a dial to a predetermined position. When the “scan mode small” is selected, the image sensor driving circuit 192 sets the image capturing area of the image sensor 191 to a predetermined area (with a read width of 3 cm, for example). Then, by taking the pressing of the scanning start/transmission button 132 as a trigger, image data captured from the image sensor 191 is stored in the image storage memory 120.

Similarly, when the “scan mode middle” is selected, the image sensor driving circuit 192 sets the image capturing area of the image sensor 191 to a predetermined area (with a read width of, for example, 5 cm, or 9 cm for the “scan mode large”). Then, by taking the pressing of the scanning start/transmission button 132 as a trigger, image data captured from the image sensor 191 is stored in the image storage memory 120. The RAM 12 is made of an SRAM (Static Random Access Memory), a flush memory or the like, and stores temporary data which is generated during the execution of software.

The storage unit 15 stores an identification information storage file 151 and a character/image data file 152. In the identification information storage file 151, the identification information of the mobile phone 2 is stored. The identification information given to the mobile phone 2 is, for example, the telephone number, electronic mail address, password, model code, or serial number of the mobile phone. Here, the password is a number inputted by the user to protect data, and determined, for example, by four digits. The model code is a code such as, for example, “FX-504V”, given for each type of mobile phone 2 by each manufacturer. The serial number is unique product ID given for each mobile phone 2, and indicated by, for example, 16 digits.

In the identification information storage file 151, no identification information is stored initially, and the identification information of a mobile phone 2 to be initially registered is stored when the mobile phone 2 is purchased, or after initialization. After storing the identification information, it is determined whether the identification number obtained from the mobile phone 2 and this stored identification information correspond to each other, and image data is transmitted according to the authentication status. In the character/image data file 152, templates of character data or image data for use in performing image processing are stored.

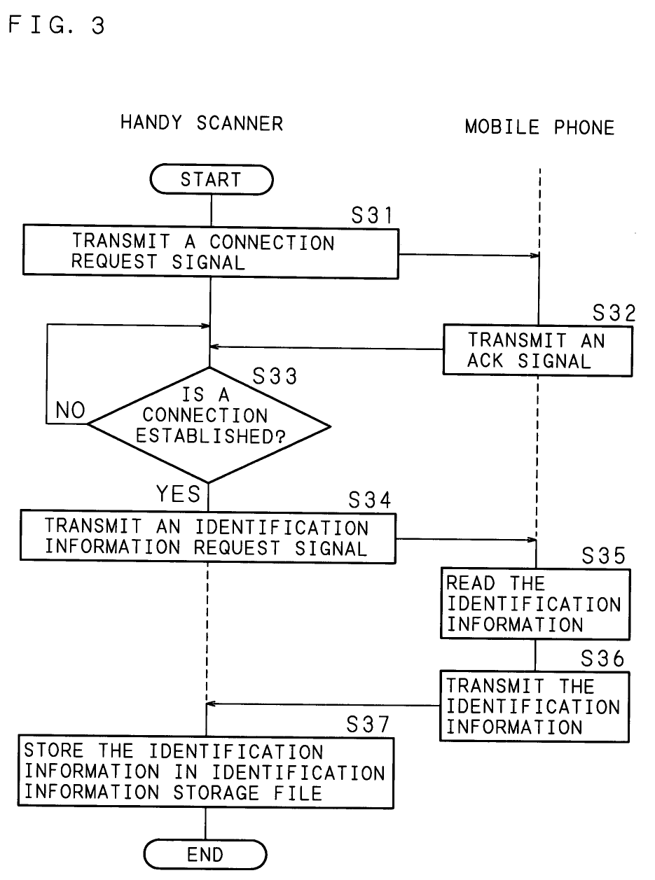

Referring to the flow chart, the following description will explain the transmission process of the present invention according to the above-described structure. FIG. 3 is a flow chart showing the procedure for initial registration of identification information. When a handy scanner 1 is purchased, the user or the sales person fits the communication section 16 of the handy scanner 1 into the external device I/F 261 of a mobile phone 2 to establish a connection. In order to request the mobile phone 2 to start communication, the CPU 11 of the handy scanner 1 transmits a connection request signal (step S31). When the controller (not shown) of the mobile phone 2 receives the connection request signal, it transmits an ACK signal to the handy scanner 1 (step S32). After transmitting the connection request signal, the CPU 11 of the handy scanner 1 determines whether or not a connection (communication) is established between the handy scanner 1 and the mobile phone 2 (step S33).

If the connection is not established (NO in step S33), the CPU 11 repeats the above-mentioned process. On the other hand, if the CPU 11 receives the ACK signal from the mobile phone 2 and determines that the connection is established (YES in step S33), it transmits an identification information request signal so as to obtain the identification information of the currently connected mobile phone 2 (step S34). For example, when the identification information is the phone number of the mobile phone 2, the CPU 11 transmits a request signal to obtain the address and phone number in a memory (not shown) installed to the mobile phone 2 with the registered phone number, according to the communication protocol for the mobile phone 2. When the controller of the mobile phone 2 receives the identification information request signal, it reads the identification information stored in the memory (step S35), and transmits the information to the handy scanner 1 (step S36). The handy scanner 1 obtains the transmitted identification information, i.e., stores the identification information in the identification information storage file 151 (step S37). The initial registration of the identification information is completed through the above-described process.

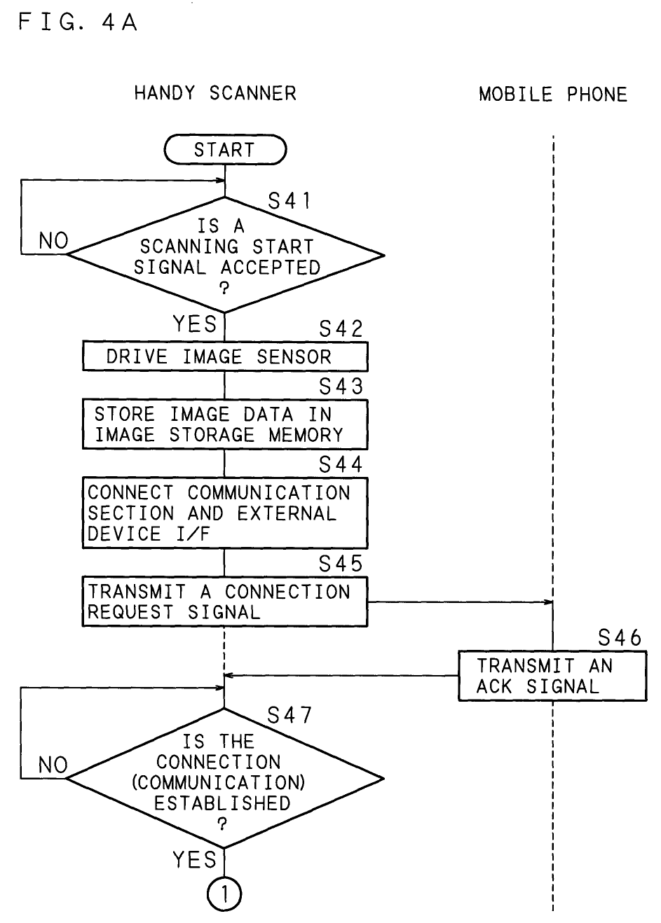

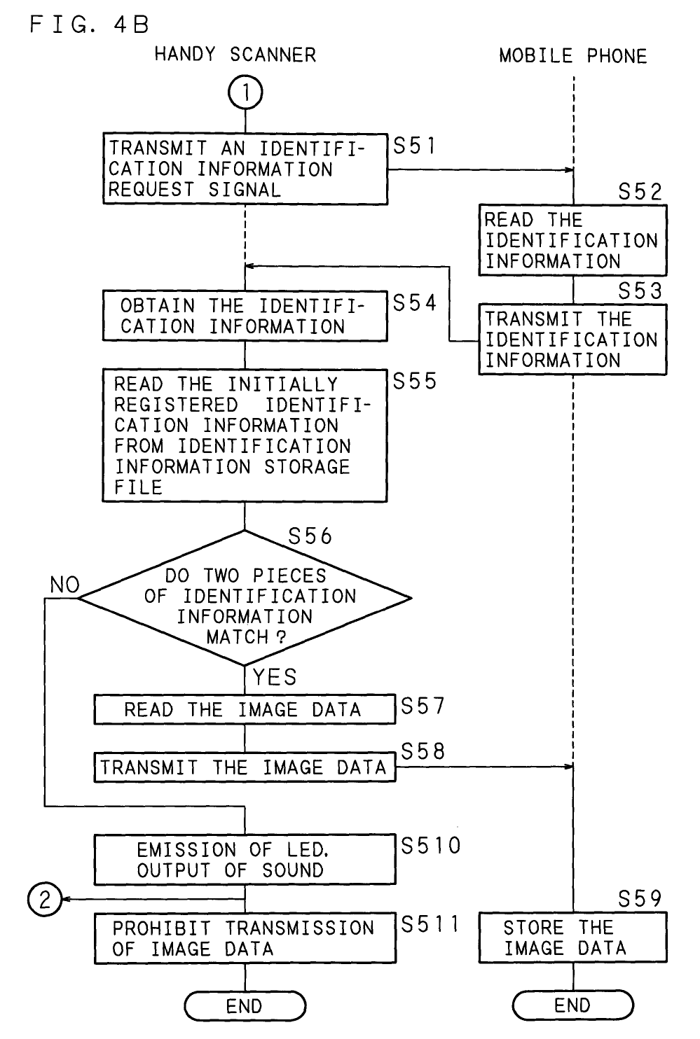

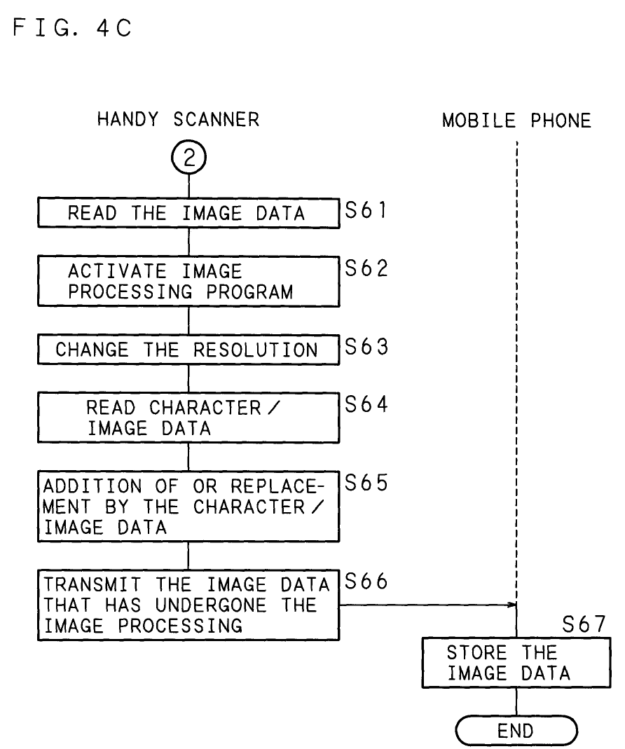

FIGS. 4A through 4C are a flow chart showing the procedure for performing the authentication process and transmission process. To capture an image, the user dials the mode selection button 131 to the “scan mode”, and presses the scanning start/transmission button 132. In this case, a scanning start signal is outputted to the CPU 11. The CPU 11 determines whether the scanning start signal is accepted or not (step S41). If the scanning start signal is not accepted (NO in step S41), the CPU 11 waits until the scanning start signal is accepted. On the other hand, if the scanning start/transmission button 132 is pressed under the “scan mode” and the scanning start signal is accepted (YES in step S41), the CPU 11 drives the image sensor 191 (step S42) to capture the image. The captured image data is stored in the image storage memory 120 together with information such as the information about the size of the image data and date information (step S43).

Subsequently, the user fits the communication section 16 of the handy scanner 1 into the external device I/F 261 of the mobile phone 2 to establish a connection (step S44). In order to request the mobile phone 2 to start communication, the CPU 11 transmits a connection request signal (step S45). When the controller (not shown) of the mobile phone 2 receives the connection request signal, it transmits an ACK signal to the handy scanner 1 (step S46). After transmitting the connection request signal, the CPU 11 of the handy scanner 1 determines whether or not a connection (communication) is established between the handy scanner 1 and the mobile phone 2 (step S47).

If the connection is not established (NO in step S47), the CPU 11 repeats the above-mentioned process. On the other hand, if the CPU 11 receives the ACK signal from the mobile phone 2 and determines that the connection is established (YES in step S47), it transmits an identification information request signal so as to obtain the identification information of the currently connected mobile phone 2 (step S51). When the controller of the mobile phone 2 receives the identification information request signal, it reads the identification information stored in the memory (not shown) (step S52), and transmits the information to the handy scanner 1 (step S53). Note that since this process is described in detail above, the detailed explanation is omitted. The handy scanner 1 obtains the transmitted identification information (step S54), i.e., temporarily stores the identification information in the RAM 12.

The CPU 11 reads the initially registered identification information from the identification information storage file 151 (step S55). The CPU 11 compares the read initially registered identification information with the obtained identification information stored in the RAM 12, and determines whether or not they match (step S56). If it is determined that the identification information matches (YES in step S56), the CPU 11 determines that it is the mobile phone 2 of a user having access rights and then reads the captured image data from the image storage memory 120 (step S57). The CPU 11 transmits the read image data to the mobile phone 2 (step S58). Note that this image data transmission is performed according to a predetermined protocol such as the transmission timing and the destination address. The mobile phone 2 stores the transmitted image data at a predetermined address (step S59). The user can enjoy the captured image by operating the mobile phone 2 and setting the captured image as the standby screen, etc.

In step S56, if it is determined that the identification information does not match (NO in step S56), the CPU 11 determines that it is the mobile phone 2 of a person having no access rights, and outputs a signal to cause the LED 14 to emit light or cause a sound signal to be outputted from the speaker (step S510). Then, the CPU 11 stops reading of image data, and prohibits the transmission of image data to the mobile phone 2 (step S511). Thus, even when the handy scanner 1 is lost, the captured image will never be browsed and privacy is protected adequately.

Note that although the image data transmission prohibiting process is explained as the process performed after step S510, the process as shown in FIG. 4C may be performed. After the process in step S510, the CPU 11 reads the captured image data from the image storage memory 120 (step S61). Then, the CPU 11 activates the image processing program 121P (step S62), and performs image processing so as to change the resolution of the read image data (step S63). More specifically, the CPU 11 performs such a process as to smooth a group of pixels around a specific pixel. In addition, the CPU 11 reads pre-stored character data or image data from the character/image data file 152 (step S64), and performs image processing to add the read character data or image data to the image data having the changed resolution, or replace the image data having the changed resolution by the read character data or image data (step S65). In the image addition process, the character data or image data and the image data having the changed resolution are combined. In the image replacing process, only the character data or image data is transmitted to the mobile phone 2, instead of the image data having the changed resolution or the image data with resolution before changed. Note that, in this embodiment, although the image processing to change the resolution and the processing to add/replace character data/image data are performed, it is possible to perform only one of these image processing operations. Besides, the image processing is not limited to the above-described modes, and it is possible to perform other image processing if it makes the original image data hard to be recognized.

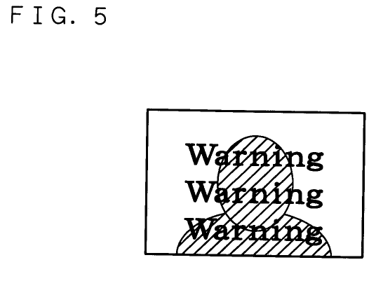

The CPU 11 transmits the image data that has undergone the image processing to the connected mobile phone 2 (step. S66). The mobile phone 2 stores the transmitted image data that has undergone the image processing at the predetermined address (step S67). In this case, the image data that has undergone the image processing is displayed on the display section of the mobile phone 2. FIG. 5 is an explanatory view showing the image of the image data displayed on the display section 24. In the example shown in FIG. 5, the image processing to combine the original image data and character data was performed. As shown in FIG. 5, the character data “Warning” is combined with the original image data. It is thus possible to give warning to the person who unjustly obtains the mobile phone 2. Moreover, even when the handy scanner 1 is lost, the captured image will never be browsed and privacy is protected adequately. Note that, in this embodiment, although the character data is combined onto the captured image data, it is possible to transmit and display the pre-registered image data/character data as it is in place of the captured image data.

Second Embodiment

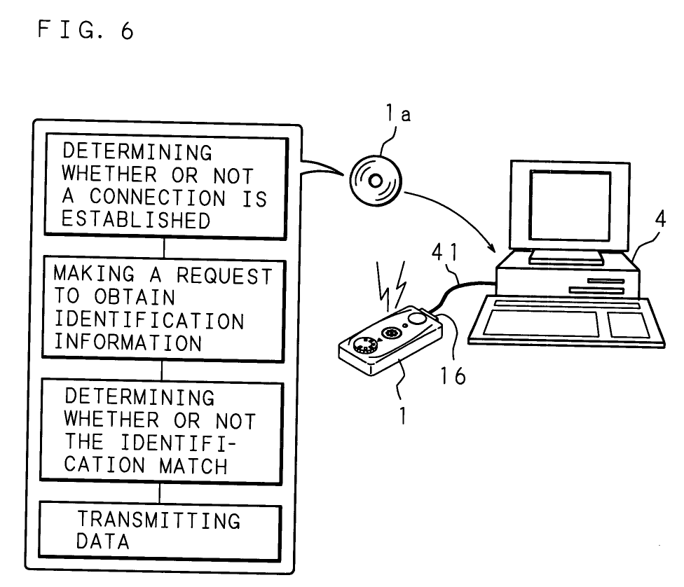

FIG. 6 is a schematic view showing the outline of a handy scanner 1, etc. according to the second embodiment. A computer program for operating the handy scanner 1 according to the above-described first embodiment can be provided by a removable memory product such as a CD-ROM and an MO through a personal computer 4 as in the second embodiment. Moreover, it is also possible to provide the computer program by propagating it as a carrier wave via a network. Its contents will be explained below.

By inserting into a memory product reader (not shown) of the personal computer 4 shown in FIG. 6 a memory product la (such as a CD-ROM, MO, or DVD-ROM) storing a program to cause a computer to determine whether or not a connection is established, make a request for identification information, determine whether or not the identification information matches, and transmit data, this program is installed in the storage unit 15 of the handy scanner 1 through a USB cable 41. Alternatively, the program may be downloaded from an external computer through a modem (not shown) of the handy scanner 1 and installed in the storage unit 15. This program is loaded in the RAM 12 of the handy scanner 1 and executed. Consequently, the program functions as the handy scanner 1 of the present invention as described above.

The second embodiment is constructed as described above. Since other structures and functions are the same as those of the first embodiment, the corresponding parts are designated with the same reference numbers and the detailed explanation thereof is omitted.

As described in detail above, in the present invention, when the image transmitter and a mobile phone are connected, it is determined whether or not a connection is established between the communication section and the mobile phone. The image transmitter transmits to the mobile phone a request signal to obtain identification information given to the mobile phone. The image transmitter determines whether or not the pre-stored identification information in the storage unit matches the obtained identification information. If it is determined that the identification information matches, the image transmitter reads the image data stored in the storage unit and transmits the image data to the mobile phone. It is thus possible to prevent mobile phones persons other than a person having access rights from being connected and displaying image data. Moreover, since there is no need to enter a password, etc., a high security image transmitter can be provided at low cost without newly mounting hardware devices such as an operation button and a display screen.

Furthermore, in the present invention, the image transmitter determines whether or not the pre-stored identification information in the storage unit matches the obtained identification information match. If it is determined that the identification information does not match, the image transmitter prohibits a transmission of an image, or performs image processing on the image data to be transmitted. Therefore, even when a third party obtains the image transmitter, the image data can not be properly displayed on the mobile phone of the third party, and thus the present invention can produce advantages effects such as adequate protection for privacy.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image transmitting method for storing image data captured from an image capturing unit of an image transmitter in a storage unit, reading the stored image data and transmitting the read image data from a communication section to a mobile phone having a display section, comprising the steps of:
pre-storing identification information given to the mobile phone in the storage unit;
determining whether or not a connection is established between the communication section and the mobile phone;
requesting the mobile phone to obtain identification information given to the mobile phone, if it is determined that the connection is established;
determining whether or not the pre-stored identification information in the storage unit and the identification information obtained in the requesting step match; and
reading the image data stored in the storage unit and transmitting the image data to the mobile phone, if it is determined in the determining step that the identification information matches.

2. An image transmitter comprising:
an image capturing unit for capturing image data;
a storage unit for storing the captured image data;
a communication section for transmitting the image data stored in the storage unit to a mobile phone having a display section; and
a processor capable of performing the following operations comprising the steps of:
determining whether or not a connection is established between the communication section and the mobile phone;
requesting the mobile phone to obtain identification information given to the mobile phone, if it is determined that the connection is established;
determining whether or not pre-stored identification information in the storage unit and the identification information obtained in the requesting step match; and
reading the image data stored in the storage unit and transmitting the image data to the mobile phone, if it is determined in the determining step that the identification information matches.

3. The image transmitter of claim 2,
wherein the processor is further capable of performing the step of prohibiting a transmission of the image data stored in the storage unit to the mobile phone, if it is determined in the determining step that the identification information does not match.

4. The image transmitter of claim 2,
wherein the processor is further capable of performing:
an image processing step of performing image processing on the image data stored in the storage unit, if it is determined in the determining step that the identification information does not match; and
the step of transmitting the image data on which the image processing was performed in the image processing step to the mobile phone.

5. The image transmitter of claim 2,
wherein the processor is further capable of performing the step of providing information indicating that the identification information does not match, if it is determined in the determining step that the identification information does not match.

6. The image transmitter of claim 2,
wherein the identification information is a phone number, an electronic mail address, a password, a model code, or a serial number of the mobile phone.

7. The image transmitter of claim 4,
wherein the image processing step adds pre-stored character data or image data in the storage unit to the image data stored in the storage unit, or replace the image data stored in the storage unit by the pre-stored character data or image data.

8. The image transmitter of claim 4,
wherein the image processing step changes resolution of the image data stored in the storage unit.

9. An image transmitter comprising:
an image capturing unit for capturing image data;
a storage unit for storing the captured image data;
a communication section for transmitting the image data stored in the storage unit to a mobile phone having a display section;
means for determining whether or not a connection is established between the communication section and the mobile phone;
requesting means for requesting the mobile phone to obtain identification information given to the mobile phone, if it is determined that the connection is established;
determining means for determining whether or not pre-stored identification information in the storage unit and the identification information obtained by the requesting means match; and
means for reading the image data stored in the storage unit and transmitting the image data to the mobile phone, if it is determined by the determining means that the identification information matches.

10. The image transmitter of claim 9, further comprising means for prohibiting a transmission of the image data stored in the storage unit to the mobile phone, if it is determined by the determining means that the identification information does not match.

11. The image transmitter of claim 9, further comprising:
image processing means for performing image processing on the image data stored in the storage unit, if it is determined by the determining means that the identification information does not match; and
means for transmitting the image data on which the image processing was performed by the image processing means to the mobile phone.

12. The image transmitter of claim 9, further comprising means for providing information indicating that the identification information does not match, if it is determined by the determining means that the identification information does not match.

13. The image transmitter of claim 9,
wherein the identification information is a phone number, an electronic mail address, a password, a model code, or a serial number of the mobile phone.

14. The image transmitter of claim 11,
wherein the image processing means is designed to add pre-stored character data or image data in the storage unit to the image data stored in the storage unit, or replace the image data stored in the storage unit by the pre-stored character data or image data.

15. The image transmitter of claim 11,
wherein the image processing means is designed to change resolution of the image data stored in the storage unit.

16. A memory product storing a computer program for storing image data captured from an image capturing unit in a storage unit, reading the stored image data and transmitting the read image data from a communication section to a mobile phone having a display section, said computer program comprising the steps of:
causing a computer to determine whether or not a connection is established between the communication section and the mobile phone;
causing the computer to request the mobile phone to obtain identification information given to the mobile phone, if it is determined that the connection is established;
causing the computer to determine whether or not pre-stored identification information in the storage unit matches the identification information obtained in the requesting step, and
causing the computer to read the image data stored in the storage unit and transmit the image data to the mobile phone, if it is determined in the determining step that the identification information matches.
